(19) United States
(12) Patent Application Publication
(10) Pub. No.: US 2016/0019353 A1
(43) Pub. Date: Jan. 21, 2016

(54) PROXY AUTHORIZATION SERVICE OBJECT ORIENTED SYSTEM AND METHOD

(71) Applicant: MyProxy Inc., Rochester, NY (US)

(72) Inventors: James Cavagnaro, Pittsford, NY (US); Frances A. Pullano, Rochester, NY (US); Kevin Richard Erdman, Indianapolis, IN (US)

(21) Appl. No.: 14/803,215

(22) Filed: Jul. 20, 2015

Related U.S. Application Data
(60) Provisional application No. 62/026,897, filed on Jul. 21, 2014.

(51) Int. Cl. G06F 19/00; H04W 8/18; H04W 4/22; G06Q 50/00

(52) U.S. Cl. CPC G06F 19/322; G06Q 50/01; H04W 8/18; H04W 4/22

(57) ABSTRACT

The present invention involves an emergency contact system and method which allows emergency personnel to reach an individual's designated contacts during an emergency in which the individual is incapacitated. A server provides health care information in case of emergency. The server has a depository module for storing health care information relating to a first individual. The server also has a directory module for associating the first individual with the health care information, a token access code; and a list of proxy contacts. The server further has a communications module for providing information relating to the proxy contacts when presented with a token access code. The communications module may also provide the health care information to a proxy contact. The depository also stores documents relating to the first individual. The server also includes an interactive telephony system.

### CROSS-REFERENCE TO RELATED APPLICATIONS

The present application claims priority under 35 U.S.C. §119(e) of U.S. Provisional Patent Application Ser. No. 62/026,897, filed Jul. 21, 2014, the disclosures of which are incorporated by reference herein.

### BACKGROUND OF THE INVENTION

1. Field of the Invention

The invention relates to emergency contact systems. More specifically, but not exclusively, the field of the invention is that of directory software for health care related information and documents.

2. Description of the Related Art

Health care documents and information are essential to delivering proper medical treatment to patients. Doctors often use electronic health records of an individual to make treatment decisions, and also will provide deference to medical directing documents and to individuals having a health care power of attorney. In the emergency setting, often conventional health care information and documents are not available to the emergency medical personnel. Bracelets identifying an individual as a diabetic or as having a particular blood type are known. Also, such items may have tags with links to internet web sites that further identify the individual. However, these existing systems only address a subset of the potential difficulties in treating an emergency medical patient.

### SUMMARY OF THE INVENTION

The present invention is a telecommunications based system and method which allows for an individual to designate other individuals as proxies to provide emergency medical personnel with information and documents that might be needed for that individual. A token carried by the person who is subject to emergency medical procedures contains a code that connects an emergency care giver to a proxy agent who by use of the inventive system may provide health care information and directives based on information and documents previously stored by the individual.

In one embodiment, the protected individual sets up a deposit of health care information and documents with a depository, the depository keying the health care information and documents with a particular code and providing the protected individual with a token that bears the key. The protected individual then designates one or more other individuals as proxies for accessing the deposit in case of an emergency. Those one or more proxies are invited to set up an account with the depository, so that in the event that a third party (e.g., emergency medical personnel) needs medical information or authorization, the third party may contact the proxy. The proxy may then contact the depository and present the key or other authentication information, so that the depository may verify the identity of the proxy. With such verification, the depository may then provide the health care information and documents to assist the proxy in dealing with the emergency medical personnel. Assuming that the protected individual carries the token with their person, in the event of an emergency the emergency personnel may find the token, contact the depository for the identity and communication with one or more proxies, then work with the proxies to provide treatment for the protected person.

Thus, embodiments of the invention provide a point of immediate contact and a direct link to someone who cares and is connected to the protected person. Anyone who finds the protected person in a condition unable to speak for him/herself whether due to medical emergency, physical incapacitation or victim of disaster may rest assured that the “MY PROXY” medal (tag) or metal wallet card would allow him/her to immediately locate and enter the engraved victim's Initials and Code into the CONTACTMYPROXY.COM website. That entry provides the designated proxy names and phone numbers of the protected person, and may be used to directly initiate communication with the proxy. Data is verified via email/mail reminders every 6 months. Inactive accounts are so designated on-line.

The present invention, in one form, relates to a secure 24/7 website directory where contact names and numbers (email contact form) are stored. Emergency personnel may use the information on the token to use the directory service. These embodiments allow for simply entering the initials and ID number will “display” the members' designated contact information. Those designated contacts, or proxies, may then be contacted to obtain the protected individual's health care information.

### BRIEF DESCRIPTION OF THE DRAWINGS

The above mentioned and other features and objects of this invention, either alone or in combinations of two or more, and the manner of attaining them, will become more apparent and the invention itself will be better understood by reference to the following description of an embodiment of the invention taken in conjunction with the accompanying drawings, wherein:

FIG. 1 is a schematic diagrammatic view of a network system in which embodiments of the present invention may be utilized.

FIG. 2 is a block diagram of a computing system (either a server or client, or both, as appropriate), with optional input devices (e.g., keyboard, mouse, touch screen, etc.) and output devices, hardware, network connections, one or more processors, and memory/storage for data and modules, etc. which may be utilized in conjunction with embodiments of the present invention.

FIG. 3 is a schematic diagram of the operation of one embodiment of the present invention relating to a protected individual and his/her proxies.

FIG. 4 is a web site screen shot of one embodiment of the invention called myproxy.

Corresponding reference characters indicate corresponding parts throughout the several views. Although the drawings represent embodiments of the present invention, the drawings are not necessarily to scale and certain features may be exaggerated in order to better illustrate and explain the full scope of the present invention. The flow charts and screen shots are also representative in nature, and actual embodiments of the invention may include further features or steps not shown in the drawings. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. A computer generally includes a processor for executing instructions and memory for storing instructions and data. When a general purpose computer has a series of machine encoded instructions stored in its memory, the computer operating on such encoded instructions may become a specific type of machine, namely a computer particularly configured to perform the operations embodied by the series of instructions. Some of the instructions may be adapted to produce signals that control operation of other machines and thus may operate through those control signals to transform materials far removed from the computer itself. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic pulses or signals capable of being stored, transferred, transformed, combined, compared, and otherwise manipulated. It proves convenient at times, principally for reasons of common usage, to refer to these signals as bits, values, symbols, characters, display data, terms, numbers, or the like as a reference to the physical items or manifestations in which such signals are embodied or expressed. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of embodiments of the present invention; the operations are machine operations. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher level coding of the instructions that is interpreted to obtain the actual computer code. The software module may also include a hardware component, wherein some aspects of the algorithm are performed by the circuitry itself rather as a result of an instruction.

Some embodiments of the present invention also relate to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus unless explicitly indicated as requiring particular hardware. In some cases, the computer programs may communicate or relate to other programs or equipments through signals configured to particular protocols which may or may not require specific hardware or programming to interact. In particular, various general purpose machines may be used with programs written in accordance with the teachings herein, or it may prove more convenient to construct more specialized apparatus to perform the required method steps. The required structure for a variety of these machines will appear from the description below.

Embodiments of the present invention may deal with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system may be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which may be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks may access the network resources, such as shared data files, common peripheral devices, and inter-workstation communication. Users activate computer programs or network resources to create “processes” which include both the general operation of the computer program along with specific operating characteristics determined by input variables and its environment. Similar to a process is an agent (sometimes called an intelligent agent), which is a process that gathers information or performs some other service without user intervention and on some regular schedule. Typically, an agent, using parameters typically provided by the user, searches locations either on the host machine or at some other point on a network, gathers the information relevant to the purpose of the agent, and presents it to the user on a periodic basis. A “module” refers to a portion of a computer system and/or software program that carries out one or more specific functions and may be used alone or combined with other modules of the same system or program.

The term “desktop” means a specific user interface which presents a menu or display of objects with associated settings for the user associated with the desktop. When the desktop accesses a network resource, which typically requires an application program to execute on the remote server, the desktop calls an Application Program Interface, or “API”, to allow the user to provide commands to the network resource and observe any output. The term “Browser” refers to a program which is not necessarily apparent to the user, but which is responsible for transmitting messages between the desktop and the network server and for displaying and interacting with the network user. Browsers are designed to utilize a communications protocol for transmission of text and graphic information over a world wide network of computers, namely the “World Wide Web” or simply the “Web”. Examples of Browsers compatible with one or more embodiments of the present invention include the Chrome browser program developed by Google Inc. of Mountain View, Calif. (Chrome is a trademark of Google Inc.), the Safari browser program developed by Apple Inc. of Cupertino, Calif. (Safari is a registered trademark of Apple Inc.), Internet Explorer program developed by Microsoft Corporation (Internet Explorer is a trademark of Microsoft Corporation), the Opera browser program created by Opera Software ASA, or the Firefox browser program distributed by the Mozilla Foundation (Firefox is a registered trademark of the Mozilla Foundation). Although the following description details such operations in terms of a graphic user interface of a Browser, one or more embodiments of the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).[0060] Similarly, JavaScript Object Notation (JSON) may be used to convert between data file formats.

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a first device, e.g. a handheld device, and a second device, e.g. a desktop computer, either via wires or wirelessly. Synchronization ensures that the data on both devices are identical (at least at the time of synchronization).

Data may also be synchronized between computer systems and telephony systems. Such systems are known and include keypad based data entry over a telephone line, voice recognition over a telephone line, and voice over internet protocol (“VoIP”). In this way, computer systems may recognize callers by associating particular numbers with known identities. More sophisticated call center software systems integrate computer information processing and telephony exchanges. Such systems initially were based on fixed wired telephony connections, but such systems have migrated to wireless technology.

In wireless wide area networks, communication primarily occurs through the transmission of radio signals over analog, digital cellular or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), Third Generation (wideband or “3G”), Fourth Generation (broadband or “4G”), personal digital cellular (“PDC”), or through packet-data technology over analog systems such as cellular digital packet data (CDPD″) used on the Advance Mobile Phone Service (“AMPS”).

The terms “wireless application protocol” or “WAP” mean a universal specification to facilitate the delivery and presentation of web-based data on handheld and mobile devices with small user interfaces. “Mobile Software” refers to the software operating system which allows for application programs to be implemented on a mobile device such as a mobile telephone or PDA. Examples of Mobile Software are Java and Java ME (Java and JavaME are trademarks of Sun Microsystems, Inc. of Santa Clara, Calif.), BREW (BREW is a registered trademark of Qualcomm Incorporated of San Diego, California), Windows Mobile (Windows is a registered trademark of Microsoft Corporation of Redmond, Wash.), Palm OS (Palm is a registered trademark of Palm, Inc. of Sunnyvale, Calif.), Symbian OS (Symbian is a registered trademark of Symbian Software Limited Corporation of London, United Kingdom), ANDROID OS (ANDROID is a registered trademark of Google, Inc. of Mountain View, Calif.), and iPhone OS (iPhone is a registered trademark of Apple, Inc. of Cupertino, Calif.), and Windows Phone 7. “Mobile Apps” refers to software programs written for execution with Mobile Software.

In the following specification, the term “social network” may be used to refer to a multiple user computer software system that allows for relationships among and between users (individuals or members) and content assessable by the system. Generally, a social network is defined by the relationships among groups of individuals, and may include relationships ranging from casual acquaintances to close familial bonds. In addition, members may be other entities that may be linked with individuals. The logical structure of a social network may be represented using a graph structure. Each node of the graph may correspond to a member of the social network, or content assessable by the social network. Edges connecting two nodes represent a relationship between two individuals. In addition, the degree of separation between any two nodes is defined as the minimum number of hops required to traverse the graph from one node to the other. A degree of separation between two members is a measure of relatedness between the two members.

Social networks may comprise any of a variety of suitable arrangements. An entity or member of a social network may have a profile and that profile may represent the member in the social network. The social network may facilitate interaction between member profiles and allow associations or relationships between member profiles. Associations between member profiles may be one or more of a variety of types, such as friend, co-worker, family member, business associate, common-interest association, and common-geography association. Associations may also include intermediary relationships, such as friend of a friend, and degree of separation relationships, such as three degrees away. Associations between member profiles may be reciprocal associations. For example, a first member may invite another member to become associated with the first member and the other member may accept or reject the invitation. A member may also categorize or weigh the association with other member profiles, such as, for example, by assigning a level to the association. For example, for a friendship-type association, the member may assign a level, such as acquaintance, friend, good friend, and best friend, to the associations between the member's profile and other member profiles.

Each profile within a social network may contain entries, and each entry may comprise information associated with a profile. Examples of entries for a person profile may comprise contact information such as an email addresses, mailing address, instant messaging (or IM) name, or phone number; personal information such as relationship status, birth date, age, children, ethnicity, religion, political view, sense of humor, sexual orientation, fashion preferences, smoking habits, drinking habits, pets, hometown location, passions, sports, activities, favorite books, music, TV, or movie preferences, favorite cuisines; professional information such as skills, career, or job description; photographs of a person or other graphics associated with an entity; or any other information or documents describing, identifying, or otherwise associated with a profile. Entries for a business profile may comprise industry information such as market sector, customer base, location, or supplier information; financial information such as net profits, net worth, number of employees, stock performance; or other types of information and documents associated with the business profile.

A member profile may also contain rating information associated with the member. For example, the member may be rated or scored by other members of the social network in specific categories, such as humor, intelligence, fashion, trustworthiness, sexiness, and coolness. A member's category ratings may be contained in the member's profile. In one embodiment of the social network, a member may have fans. Fans may be other members who have indicated that they are “fans” of the member. Rating information may also include the number of fans of a member and identifiers of the fans. Rating information may also include the rate at which a member accumulated ratings or fans and how recently the member has been rated or acquired fans.

A member profile may also contain social network activity data associated with the member. Membership information may include information about a member's login patterns to the social network, such as the frequency that the member logs in to the social network and the member's most recent login to the social network. Membership information may also include information about the rate and frequency that a member profile gains associations to other member profiles. In a social network that comprises advertising or sponsorship, a member profile may contain consumer information. Consumer information may include the frequency, patterns, types, or number of purchases the member makes, or information about which advertisers or sponsors the member has accessed, patronized, or used.

A member profile may comprise data stored in memory. The profile, in addition to comprising data about the member, may also comprise data relating to others. For example, a member profile may contain an identification of associations or virtual links with other member profiles. In one embodiment, a member's social network profile may comprise a hyperlink associated with another member's profile. In one such association, the other member's profile may contain a reciprocal hyperlink associated with the first member's profile. A member's profile may also contain information excerpted from another associated member's profile, such as a thumbnail image of the associated member, his or her age, marital status, and location, as well as an indication of the number of members with which the associated member is associated. In one embodiment, a member's profile may comprise a list of other social network members' profiles with which the member wishes to be associated.

An association may be designated manually or automatically. For example, a member may designate associated members manually by selecting other profiles and indicating an association that may be recorded in the member's profile. According to one embodiment, associations may be established by an invitation and an acceptance of the invitation. For example, a first user may send an invitation to a second user inviting the second user to form an association with the first user. The second user may accept or reject the invitation. According to one embodiment, if the second user rejects the invitation, a one-way association may be formed between the first user and the second user. According to another embodiment, if the second user rejects the association, no association may be formed between the two users. Also, an association between two profiles may comprise an association automatically generated in response to a predetermined number of common entries, aspects, or elements in the two members' profiles. In one embodiment, a member profile may be associated with all of the other member profiles comprising a predetermined number or percentage of common entries, such as interests, hobbies, likes, dislikes, employers and/or habits. Associations designated manually by members of the social network, or associations designated automatically based on data input by one or more members of the social network, may be referred to as user established associations.

Examples of social networks include, but are not limited to, Facebook, Twitter, Myspace, LinkedIn, Google Plus and Google Circles, and other systems. The exact terminology of certain features, such as associations, fans, profiles, etc. may vary from social network to social network, although there are several functional features that are common to the various terms. Thus, a particular social network may have more of less of the common features described above. In terms of the following disclosure, generally the use of the term “social network” encompasses a system that includes one or more of the foregoing features or their equivalents.

“PACS” refers to Picture Archiving and Communication System (PACS) involving medical imaging technology for storage of, and convenient access to, images from multiple source machine types. Electronic images and reports are transmitted digitally via PACS; this eliminates the need to manually file, retrieve, or transport film jackets. The universal format for PACS image storage and transfer is DICOM (Digital Imaging and Communications in Medicine). Non-image data, such as scanned documents, may be incorporated using consumer industry standard formats like PDF (Portable Document Format), once encapsulated in DICOM. A PACS typically consists of four major components: imaging modalities such as X-ray computed tomography (CT) and magnetic resonance imaging (MRI) (although other modalities such as ultrasound (US), positron emission tomography (PET), endoscopy (ES), mammograms (MG), Digital radiography (DR), computed radiography (CR), etc. may be included), a secured network for the transmission of patient information, workstations and mobile devices for interpreting and reviewing images, and archives for the storage and retrieval of images and reports. When used in a more generic sense, PACS may refer to any image storage and retrieval system.

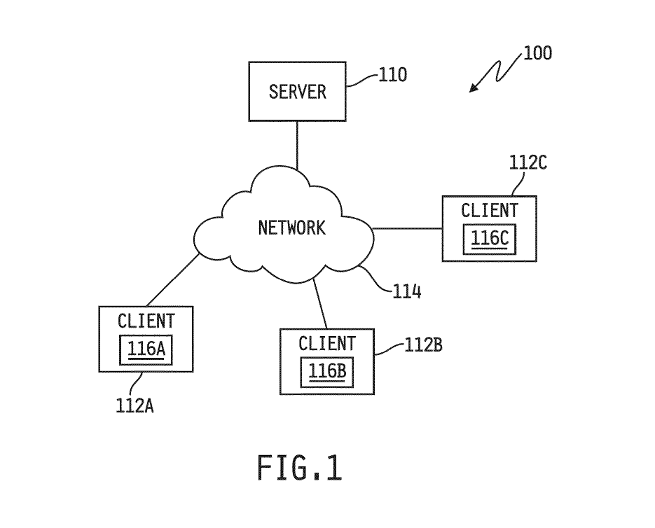

FIG. 1 is a high-level block diagram of a computing environment 100 according to one embodiment. FIG. 1 illustrates server 110 and three clients 112 connected by network 114. Only three clients 112 are shown in FIG. 1 in order to simplify and clarify the description. Embodiments of the computing environment 100 may have thousands or millions of clients 112 connected to network 114, for example the Internet. Users (not shown) may operate software 116 on one of clients 112 to both send and receive messages network 114 via server 110 and its associated communications equipment and software (not shown).

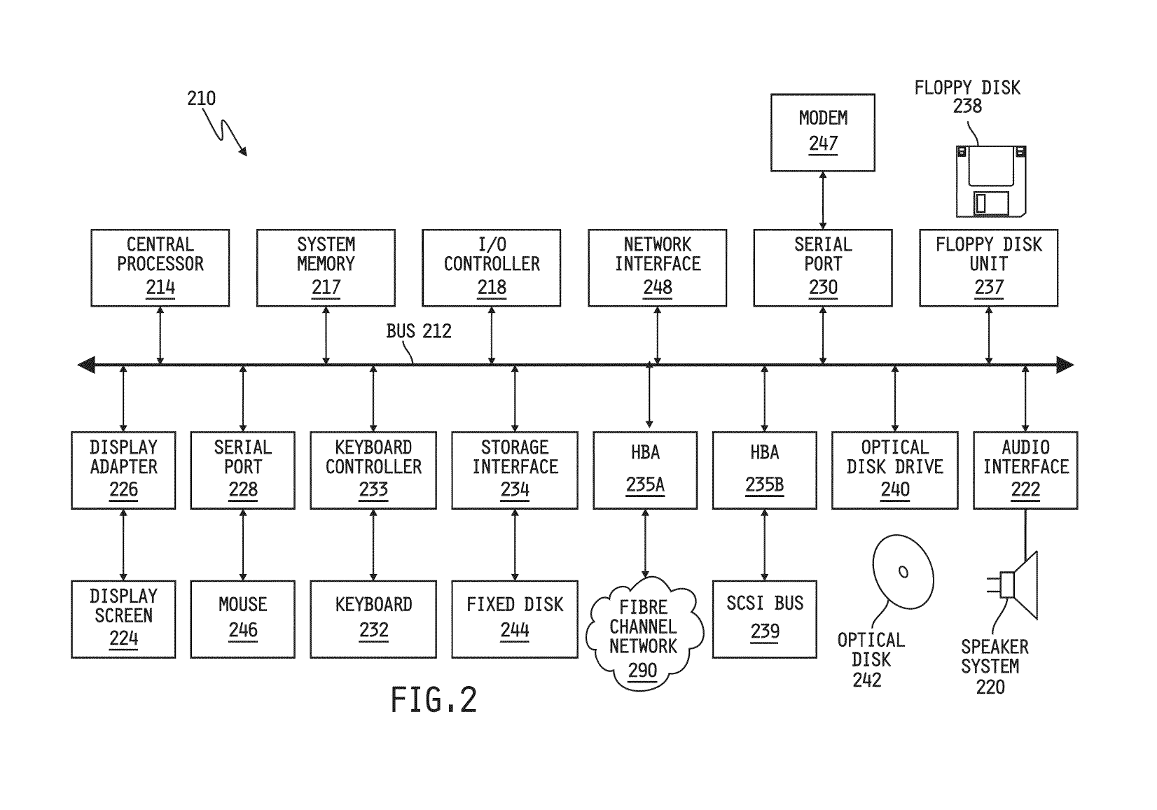

FIG. 2 depicts a block diagram of computer system 210 suitable for implementing server 110 or client 112. Computer system 210 includes bus 212 which interconnects major subsystems of computer system 210, such as central processor 214, system memory 217 (typically RAM, but which may also include ROM, flash RAM, or the like), input/output controller 218, external audio device, such as speaker system 220 via audio output interface 222, external device, such as display screen 224 via display adapter 226, serial ports 228 and 230, keyboard 232 (interfaced with keyboard controller 233), storage interface 234, disk drive 237 operative to receive floppy disk 238, host bus adapter (HBA) interface card 235A operative to connect with Fibre Channel network 290, host bus adapter (HBA) interface card 235B operative to connect to SCSI bus 239, and optical disk drive 240 operative to receive optical disk 242. Also included are mouse 246 (or other point-and-click device, coupled to bus 212 via serial port 228), modem 247 (coupled to bus 212 via serial port 230), and network interface 248 (coupled directly to bus 212).

Bus 212 allows data communication between central processor 214 and system memory 217, which may include read-only memory (ROM) or flash memory (neither shown), and random access memory (RAM) (not shown), as previously noted. RAM is generally the main memory into which operating system and application programs are loaded. ROM or flash memory may contain, among other software code, Basic Input-Output system (BIOS) which controls basic hardware operation such as interaction with peripheral components. Applications resident with computer system 210 are generally stored on and accessed via computer readable media, such as hard disk drives (e.g., fixed disk 244), optical drives (e.g., optical drive 240), removable memory (such as thumb drives, etc.) illustrated as floppy disk unit 237, or other storage medium. Additionally, applications may be in the form of electronic signals modulated in accordance with the application and data communication technology when accessed via network modem 247 or interface 248 or other telecommunications equipment (not shown).

Storage interface 234, as with other storage interfaces of computer system 210, may connect to standard computer readable media for storage and/or retrieval of information, such as fixed disk drive 244. Fixed disk drive 244 may be part of computer system 210 or may be separate and accessed through other interface systems. Modem 247 may provide direct connection to remote servers via telephone link or the Internet via an internet service provider (ISP) (not shown). Network interface 248 may provide direct connection to remote servers via direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. Devices and subsystems may be interconnected in different ways from that shown in FIG. 2. Operation of a computer system such as that shown in FIG. 2 is readily known in the art and is not discussed in detail in this application. Software source and/or object codes to implement the present disclosure may be stored in computer-readable storage media such as one or more of system memory 217, fixed disk 244, optical disk 242, or floppy disk 238. The operating system provided on computer system 210 may be a variety or version of either MS-DOS® (MS-DOS is a registered trademark of Microsoft Corporation of Redmond, Wash.), WINDOWS® (WINDOWS is a registered trademark of Microsoft Corporation of Redmond, Wash.), OS/2® (OS/2 is a registered trademark of International Business Machines Corporation of Armonk, N.Y.), UNIX® (UNIX is a registered trademark of X/Open Company Limited of Reading, United Kingdom), Linux® (Linux is a registered trademark of Linus Torvalds of Portland, Oreg.), or other known or developed operating system. In some embodiments, computer system 210 may take the form of a tablet computer, typically in the form of a large display screen operated by touching the screen. In tablet computer alternative embodiments, the operating system may be iOS® (iOS is a registered trademark of Cisco Systems, Inc. of San Jose, Calif., used under license by Apple Corporation of Cupertino, Calif.), Android® (Android is a trademark of Google Inc. of Mountain View, Calif.), Blackberry® Tablet OS (Blackberry is a registered trademark of Research In Motion of Waterloo, Ontario, Canada), webOS (webOS is a trademark of Hewlett-Packard Development Company, L.P. of Tex.), and/or other suitable tablet operating systems.

Moreover, regarding the signals described herein, those skilled in the art recognize that a signal may be directly transmitted from a first block to a second block, or a signal may be modified (e.g., amplified, attenuated, delayed, latched, buffered, inverted, filtered, or otherwise modified) between blocks. Although the signals of the above described embodiments are characterized as transmitted from one block to the next, other embodiments of the present disclosure may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

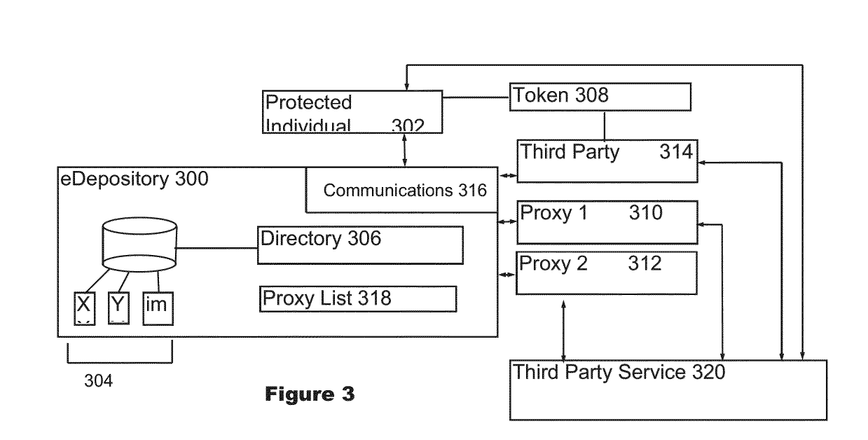

FIG. 3 illustrates the various actors and how they relate to an embodiment of the invention depicted as eDepository 300. Protected individual 302 first sets up an account with eDepository 300 and provides health care information and documents 304 for storage in eDepository 300. In this embodiment, such information and documents are provided and maintained in electronic form, and eDepository 300 is accessible over telecommunications channels such as interactive telephony systems or an internet based web server. Alternatively, a depository may alternatively be configured to store information in tangible form, and provide access through manual or automated processes.

In registering with eDepository 300, protected individual 302 has a code associated in Directory 306, and protected individual 302 is provided with a token 308 having a physical, electronic, magnetic, or other tangible embodiment of the code. In the registration process, protected individual identifies and invites at least one of individuals 310 and 312 to serve as proxies. A proxy may register by providing authentication information to allow each proxy subsequent access when contacted by third party 314, for example when an emergency medical technician discovers protected person 302 unconscious but having token 308. Third party 314 may initiate contact with communications hub 316, for example through a web portal or an interactive telephony system, to obtain contact information of one or more proxies stored in Proxy List 318 (for example, telephone numbers, e-mail addresses, instant messaging handles, and/or pager number). Third party may then contact one of proxies 310, 312 to ask for pertinent health care information or instruction from proxy 310, 312. When a proxy is contacted, that proxy may access relevant information by providing hub 316 with sufficient authentication information to then provide third party 314 with relevant information, for example recent medications that protected individual had been taking (which information was previously provided as part of health care information and documents 304). As another example, proxy 310 may find that documents 304 include a health care power of attorney naming proxy 310 as protected individual 302's health care representation. Accessing such a document and forwarding that document to third party 314 then authorizes proxy 310 to direct treatment options as appropriate for protected individual 302.

Token 308 may take one or several forms, including a Wallet Card and “charm on chain” in several possible sizes depending on personal preference. Other possible embodiments of token 308 include, but are not limited to: Bracelets, Necklaces, Ankle bracelets, and Key Chains.

Health care information and documents 304 may include Storage of living will documents, for example, by protected individual 302 having uploaded personally prepared documents from his/her own attorney, including but not limited to: DNR (do not resuscitate) instructions; a Living Will, a Health Care Proxy with Power of Attorney. Health care information and documents 304 may also include selected documents and information that an individual may consider relevant in case of an emergency, for example recent x-rays for a PAC system after a recent injury or a series of blog posts documenting protected individual 302's recent travel and/or physical history.

In some embodiments, each proxy 310, 312 has full access to all documents 304, and may also designate third parties (such as an emergency medical provider) with such full access. In other embodiments, proxy 310 may have access to only a sub-set of documents 304 (e.g., only medical history documents), while proxy 312 may have access to another portion of documents 304 (e.g., a health care proxy and power of attorney appointing proxy 312). Thus in some embodiments protected individual 302 may only designate proxy 310 and/or 312 to provide information or direct documents to third parties, while in other embodiments protected individual 302 may designate proxy 310 and/or 312 as having authority to direct health care decisions. While the above description of illustration of FIG. 3 has two proxies, other embodiments of the invention may have three or more proxies with varying levels of access to sub-sets of documents 304.

In some embodiments, third party service 320 may have a separate relationship with one or more of protected individual 302 and/or proxy contacts 310, 312. In some of those embodiments, third party service 320 includes a social network which provides a level of identification and authorization for eDepository 300. For example, in one embodiment, third party service 320 allows for a member of its service to designate one or more other members as a proxy contact. In this way, eDepository 300 may rely on the identification of proxy contact 310 or 312 from membership credentials from third party service 318. In these embodiments, eDepository 300 has an application within third party service 320 that allows for procedures similar to those described above for registration as a protected individual or a proxy contact. Having individuals identified as proxy contacts on the social network, in turn, would provide another link to the proxy in case protected individual 302 is identified such that her/his social network profile is located even though token 308 is not in the possession of third Party 314.

In other embodiments, third party service 320 includes a separate electronic records depository, for example an electronic health record depository or a legal document depository. In these embodiments, protected individual may provide eDepository 300 with one or more documents from third party service 320 directly, and allow for proxy access for other documents. In this way, protected individual 302 may provide a subset of documents to eDepository 300, with a more complete set of documents in third party service 320. Also, if medical providers have the ability to update protected individual 302′s electronic health record, this would allow the health record to be automatically updated for access through a proxy contact. Alternatively, trusted individual 302 may only provide selected legal documents to eDepository 300, and allow proxy contacts 310, 312 to access a selection of documents residing with third party service 320, for example providing proxy contacts 310, 312 with particular legal documents and allowing proxy contacts 310, 312 to send a full electronic health record to another party such as emergency medical personnel. Other information, such as recent travel or activity information, relevant to emergency treatment may additionally be available through third party service 320, such as a social network having a travel tracking feature.

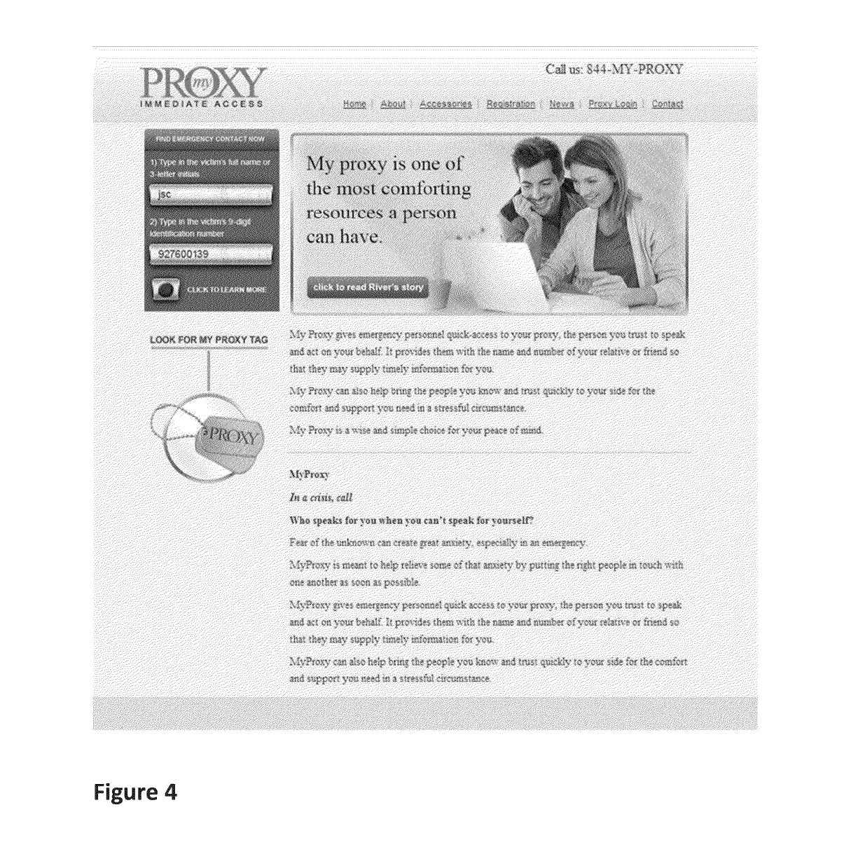

In one embodiment, the registration process involves several of the following steps: visiting eDepository 300 which in one embodiment is configured with the www.contactmyproxy.com website which may be reached via web browsing, FACEBOOK inquiry, sales contact prompting etc. Turning to FIG. 4, registration may be accomplished by clicking on the Registration tab of the site.

The Registration link allows protected individual 302 to create an account by entering personal information which may include, but is not limited to or required: FULL FIRST, MIDDLE and LAST NAME, Date-Of-Birth, ADDRESS OF RECORD, EMAIL ADDRESS. Upon entering a sufficient amount of this or other information, the system ask protected individual 302 to activate a USER NAME and PASSWORD by following prompts.

Once the USER NAME and PASSWORD have been accepted, the Member is directed to: ENTER YOUR CONTACTS, which screen prompts for proxy individual information including but not limited to or required: FULL NAME, ADDRESS OF RECORD, EMAIL ADDRESS, HOME PHONE AND CELL PHONE NUMBERS for 2 PRIMARY CONTACTs, protected individual 302's PERSONAL PHYSICIAN and protected individual 302's PERSONAL ATTORNEY, WHO MAY HOLD MEDICAL RECORDS and/or documents.

Upon completing registration, protected individual 302 is directed to “ACCESSORIES” where he/she has the opportunity to choose from at least the following options for token 308: I would like the basic 1 charm on a chain and 1 wallet card option. Check out NOW; I would like the key tag, charm on a chain and 1 wallet card option. Check out NOW; I'd like to browse wherein the system fades into more options such as enhanced/color charms, bracelets, enhanced chains etc.

Protected individual 302 may also access further features of eDepository 300 including an option to include a new health care document, by redirecting protected individual 302 to a forms page wherein options such as a Living Will, a DNR (do not resuscitate) directive, a Health Care Proxy—Power of Attorney, where in one embodiment such a forms page includes a list of state links to download forms one may complete on a self-service basis and use per State law.

At the end of the Registration process, the system may display a notice such as: “YOUR MyPROXY order is on its way to your address of record! A receipt has been sent to your email and is available BELOW. We hope you will enjoy and wear proudly your made in America MYProxy items.”

A second step in the registration process involves entering one or more proxy contacts 310, 312 is the review of the proxy contact information. The system prompts protected individual 302 to confirm the proxy contact information by: “Are you sure you would like these 2 contacts added to your file?” Assuming confirmation, the system indicates to protected individual 302: “An email has been sent to your proxy contacts, on your behalf, so that they may acknowledge designation as your MyProxy contact. We will notify you of their response within 20 days. You may also choose to notify them of your selection, via phone call. Please do so soon!”

At the end of 20 days, the system sends an email to the member and maintains the “response” of the contact in directory 306.

Each of proxy 320, 312 may acknowledge selection as a MYProxy contact by clicking the YES or NO button which generates the response email to protected individual 302 and updates directory 306. If YES, the “contact” is directed to the REGISTRATION page from the question: “Would YOU like to be a MyPRoxy member as well?”

After agreeing to participate, each proxy contact has the ability to transmit that designation so that everyone know you are part of the MY PROXY family. That way, protected individual 302 need never be unsure of who will be contacted in the event protected individual 302 is unable to communicate. eDirectory 306 provides an interface with existing social networks so proxy contact 310,312 may click on a graphic interface button to acknowledge membership on FACEBOOK, TWITTER or GOOGLE CIRCLES.

In one embodiment, if contacted by emergency medical personnel, each proxy contact 310,312 may go to contactmyproxy.com—where Primary and Alternate contacts have full access to Member info and additional contacts as listed. Information that may or may not disclosed to the public/first responders (as set up by protected individual 302) may include: Attorney, Primary Care Physician, access to storage including DNR (do not resuscitate)—Living Will—Health Care Proxy—Power of Attorney. Access by proxy contact 310, 312 may be governed by standard user authentication protocols, for example user name and password combinations (with conventional password recovery procedures) or alternatively may be governed by separate authentication tokens or other service specific authentication.

FIRST RESPONDERS (Left column of FIG. 4) allows emergency personnel via Website Access full site, in this embodiment at www.contactmyproxy.com, to enter information from token 308, in this example the combination of initials and system identification number. Entering information from token 308 into the emergency contact form portion of FIG. 4, in one embodiment, provides the following information:

The Primary Emergency contact for ______ (full name) ______ is

Sally Smith

Cell Number: XXX-XXX-XXXX

Home Number: XXX-XXX-XXXX

Work Number: XXX-XXX-XXXX

To Email this contact click here (form filled out and sent to stored e-mail address)

The Alternate Emergency contact for ______ (full name) ______ is

Jimmy Jones

Cell Number: XXX-XXX-XXXX

Home Number: XXX-XXX-XXXX

Work Number: XXX-XXX-XXXX

To Email this contact click here (form filled out and sent to stored e-mail address)

(Full Name) has a release or health care proxy on file that allows you to share any information, including health care information, with these contacts.

FIRST RESPONDERS contact via phone to IVR SYSTEM

In another embodiment, the system uses a process whereby first responders call a toll free number to access directory 306 of MyProxy contacts, for example by calling 1-844-MyProxy. In this embodiment, (the interactive telephony system responds) “you have reached the MyProxy directory. If you have not already called 911 or your local emergency responders regarding this member, please do so before continuing!” Then it prompts the caller: “If you are looking for the member's MyProxy contact, Please enter YOUR three digit initial code.” (System responds) “Please enter your 9 digit identifier.” Upon access the system states the full name of the MyProxy member and responds: “Press 1 to confirm, 2 to start again”

ALTERNATE SCENARIOS include that the MYProxy member is no longer active: “I'm sorry this member is no longer active. Call 911 for assistance.” Or that the codes entered are not valid: “I'm sorry, we cannot identify this Initial and identifier code. Would you like to try again? Press 1 to confirm. If not, call 911 for assistance with the person you have found.”

Assuming a successful log in, the interactive telephony system of this embodiment responds: “This MyProxy member (repeat the name) has designated the following people to be authorized MyProxy contacts for you to share this person's current status. You may also find this information online @ www.contactmyproxy.com” Then continues: “the primary MyProxy contact is: primary contact and phone number” pauses, then continues: “the secondary MyProxy contact is: secondary contact and phone number” then continues: “to contact the primary MyProxy contact press 1; to contact the secondary MyProxy contact press 2”

Another alternative if unsuccessful in directly putting the emergency personnel into a telephone call with the proxy: “I'm sorry, we are unable to locate the Primary or Secondary MyProxy contacts. If you would like us to text message these contacts to you, enter your 10 digit mobile number now:” pause “Please be certain this person has received the medical or other attention needed. You may also obtain this information on-line at: www.contactmyproxy.com. Thank you for calling MyPRoxy.”

In one embodiment, providing token 308 involves sending the Full Name, address, 3 initials and ID# (for example, a telephone number) to a token manufacturer to make a physical embodiment of the codes. For example, the CONTACTMYPROXY.COM CHARM/WALLET CARD/JEWELRY where “The charm” face to display logo of (MyPROXY) identifying the object as token 308, with the back side customized to the individual: CONTACTMYPROXY.COM; UNIQUE 3 initials and ID# combination. Where token 308 is a METAL Wallet card, the face FACE TO DISPLAY: Logo and URL; In the event of an emergency you may find my authorized contacts at CONTACTMYPROXY.COM; Or call 1-844-MYProxy. The back side is customized to the individual: Full Name; 3 initials and ID# combination (Similar to a credit card), with the final text: “I, ‘Full Name’ authorize individuals found in contactmyproxy.com to act on my behalf in the event I am unable to communicate for myself. Go to CONTACTMYPROXY.COM and enter my initials XXX and ID#. With these embodiments, the metal wallet card may be stored in wallet or purse, the medal charm/tag may be placed on a keychain, worn around the neck and/or worn as a bracelet or ankle charm. Token 308 may be designed as a fashion piece, possibly adding additional cost, and providing further variety. Token 308 is made of suitable durable, fireproof material, for example without limitation stainless steel.

While one or more embodiments of this invention have been described as having an illustrative design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A server for providing health care information about a first individual to a third party, said server comprising:
a depository module for storing health care information relating to a first individual;
a directory module for associating the first individual with the health care information, a token access code; and a list of at least one proxy contacts;
a communications module for evaluating authentication information and providing information relating to the first individual to the proxy contacts when presented with a token access code, the communications module configured to provide the health care information of the first individual to one of the at least one proxy contacts.

2. The server of claim 1 wherein the depository also stores documents relating to the first individual.

3. The server of claim 2 wherein the depository is configured to selectively provide access to the documents for each individual proxy contact.

4. The server of claim 2 wherein the depository is configured to provide documents to third parties designated by a proxy contact.

5. The server of claim 1 wherein said server includes an interactive telephony system.

6. The server of claim 5 wherein the interactive telephony system is configured to place a telephone call between the possessor of a token access code and at least one of the proxy contacts.

7. The server of claim 1 further comprising a social network interaction module for verifying identities through interaction with a social network.

8. The server of claim 7 wherein the depository also stores documents relating to the first individual and allows document access through a social network to an individual verified through the social network.

9. The server of claim 1 further comprising a document service interaction module for obtaining documents relating to the first individual from a third party service.

10. The server of claim 9 wherein the document interaction module provides selective access to sub-sets of the documents relating to the first individual.

11. A method for providing health care information in case of emergency, said method comprising the steps of:
storing health care information relating to a first individual in a depository on a server connected to a network;
associating the first individual with the health care information, a token access code; and a list of proxy contacts with the server;
evaluating authentication information and providing information relating to the proxy contacts when the server is presented with a token access code over the network, the server configured to provide the health care information to a proxy contact.

12. The method of claim 11 wherein the depository also stores documents relating to the first individual.

13. The method of claim 12 wherein the depository selectively provides access to the documents for each individual proxy contact.

14. The method of claim 12 wherein the depository selectively provides access to the documents to third parties designated by a proxy contact.

15. The method of claim 11 wherein the network includes an interactive telephony system.

16. The server of claim 15 wherein the interactive telephony system is configured to place a telephone call between the possessor of a token access code and at least one of the proxy contacts.

17. The method of claim 11 further including using a social network to verify identities.

18. The method of claim 17 wherein the depository also stores documents relating to the first individual and allows access to an individual verified through the social network.

19. The server of claim 11 further including the step of using a document service to provide documents relating to the first individual.

20. The server of claim 19 wherein the document service provides selective access to sub-sets of the documents relating to the first individual.
